(19) United States
(12) Patent Application Publication
(10) Pub. No.: US 2005/0146524 A1
(43) Pub. Date: Jul. 7, 2005

(54) System and method for determining a spatial hierarchy for polygonal data by using cube-root scaling

(76) Inventors: Andre Gueziec, Sunnyvale, CA (US); Dan Brockway, Dallas, TX (US); Stephen Gersuk, Plano, TX (US); Michelle Fitch, McKinney, TX (US); Mark Wear, Greensboro, NC (US)

Correspondence Address: COOPER & DUNHAM, LLP, 1185 AVENUE OF THE AMERICAS, NEW YORK, NY, 10036, US

(21) Appl. No.: 10/873,716

(22) Filed: Jun. 21, 2004

Related U.S. Application Data
(63) Continuation of application No. 10/648,144, filed on Aug. 25, 2003, now abandoned.
Application No. 10/648,144 is a continuation of application No. 10/307,737, filed on Dec. 2, 2002, now abandoned.
Application No. 10/307,737 is a continuation of application No. 10/112,500, filed on Mar. 27, 2002, now abandoned.
(60) Provisional application No. 60/279,181, filed on Mar. 27, 2001.

(51) Int. Cl. G06T 17/00

(52) U.S. Cl. 345/428

(57) ABSTRACT

A method of determining a spatial hierarchy for polygon data, comprises obtaining a switching range, and determining a polygon density for the spatial hierarchy, using the switching range and a cube-root scaling factor. Another method of determining a spatial hierarchy for polygon data, comprises determining a cube-root scaling factor based on an altitude parameter, and using the cube-root scaling factor to scale level-of-detail switching ranges for the spatial hierarchy. The methods may be embodied in a computer program (or some unit of code) stored on a computer readable medium, such as a compact disc (i.e. CD), and/or transmitted via a computer network, such as the Internet, or another transmission medium.

### CROSS-REFERENCE TO RELATED APPLICATIONS

This application claims the benefit of co-pending provisional application Ser. No. 60/279,181, filed Mar. 27, 2001 and entitled “SYSTEM AND METHOD FOR ASSIGNING POLYGON BUDGETS, RANGES AND OBJECT SIZES TO A SPATIAL HIERARCHY USING CUBE-ROOT ALTITUDE SCALING.”

### TECHNICAL FIELD

The present application relates to determining a spatial hierarchy of polygon data for representing images on a display device. More specifically, the application relates to a system and method for assigning polygon budgets, ranges, object sizes, etc., to a spatial hierarchy by using cube-root altitude scaling.

### DESCRIPTION OF THE RELATED ART

Computer generation of visual scenes is constrained by limitations in data storage and representation of objects in the scenes. A number of image rendering techniques have been proposed.

U.S. Pat. No. 4,715,005 describes a technique of computer generation of visual scenes of rolling terrain and seascape, using a database of math models. A mathematical formula determines the extent of terrain or sea that must be used to cover a portion of the display. The terrain and sea are modeled using sine waves. There is neither a description nor a suggestion of (i) using a polygonal representation and/or (ii) a hierarchical representation of the data (terrain). There is also no description or suggestion in U.S. Pat. No. 4,715,005 of adapting the technique described in the context of terrain and seascape therein to cultural features (such as buildings).

U.S. Pat. No. 5,367,615 describes spatial augmentation of vertices and continuous level of detail transition for smoothly varying terrain polygon density, in which the details are statistically derived. There is no description or suggestion in U.S. Pat. No. 4,715,005 of adapting the detail processing technique described in the context of terrain therein to cultural features (such as buildings). There also is neither a description nor a suggestion of deriving range rings mathematically.

### SUMMARY

The present application provides a system and method for determining a spatial hierarchy for polygon data. The method comprises, in accordance with one embodiment, obtaining a switching range, and determining a polygon density for the spatial hierarchy, by using the switching range and a cube-root scaling factor.

The method comprises, according to another embodiment, determining a cube-root scaling factor based on an altitude parameter, and using the cube-root scaling factor to scale level-of-detail switching ranges for the spatial hierarchy.

The methods may be embodied in a computer program (or some unit of code) stored on a computer readable medium, such as a compact disc (CD), and/or transmitted via a computer network, such as the Internet, or another transmission medium.

The application also provides a system for determining a spatial hierarchy for polygon data. In one embodiment, the system includes a user interface and a feature analyzer. The feature analyzer determines a polygon density for the spatial hierarchy by using (i) a cube-root scaling factor and (ii) a switch-in distance and switch-out distance obtained through the user interface.

The cube-root scaling factor may be determined based on an altitude parameter. The spatial hierarchy may be tile-based. The polygon data may corresponds to cultural feature.

Design parameters of the spatial hierarchy may be obtained and/or modified through the user interface. For example, one or more of the following may be obtained and/or modified through the user interface: a number of levels in the spatial hierarchy; an extent of tiles for each level of the spatial hierarchy; a critical size of polygonal elements to be inserted in each level of the spatial hierarchy; and a switching distance for tiles of each level of the spatial hierarchy.

### BRIEF DESCRIPTION OF THE DRAWINGS

The features of the present application may be more readily understood from the following detailed description by referring to the accompanying drawings wherein:

FIGS. 1A and 1B show respective two-dimensional graphical representations of a subject band of a computer screen as viewed from a selected eyepoint;

FIG. 2 shows a graphical representation of a vertical field of view;

FIG. 3 shows a graphical representation of vertical density fall-off from the center of a display screen;

FIG. 4 shows a graphical representation of horizontal density fall-off from the center of a display screen;

FIG. 5 shows a graphical representation of a ground range of a tile as a function of altitude, when scaling is turned on;

FIGS. 6A and 6B show graphical representations, in respective additive and substitutive designs, of critical distances for determining object sizes;

FIG. 7 shows an Input Sheet in a Point Feature Density Analysis Tool in accordance with one embodiment of the present application;

FIG. 8 shows an Output-TileDesign Sheet in a Point Feature Density Analysis Tool in accordance with one embodiment of the present application;

FIG. 9 shows an Output-FeatureSizes Sheet in a Point Feature Density Analysis Tool in accordance with one embodiment of the present application;

FIG. 10 shows an Output-QuadTree Sheet in a Point Feature Density Analysis Tool in accordance with one embodiment of the present application;

FIG. 11 shows a block diagram of a system, according to one embodiment of the present application, for determining a spatial hierarchy for polygon data;

FIG. 12 shows a flow chart of a method, according to one embodiment of the present application, for determining a spatial hierarchy for polygon data; and

FIG. 13 shows a flow chart of a method, according to another embodiment of the present application, for determining a spatial hierarchy for polygon data.

### DETAILED DESCRIPTION

The present application provides new methodologies (for example, in the form of a system and methods) for determining a spatial hierarchy for polygon data for representing images on a display and/or output medium (such as conventional display and output devices). In the spatial hierarchy, the level-of-detail of a displayed feature varies according to the distance between an eyepoint and the feature.

A density computation method provided by the present application may be used, along with a feature prioritization method, to provide selection of source feature data and assignment of geometric models to specific levels-of-detail of the database. The methods provided by the present application may be used to maximize a feature content in a database without exceeding the capacity of the image rendering system. The methods also may be used to achieve a constant polygon density at any elevation. The methods may be adapted for, e.g., flight simulation/visual simulation/geographic database, system or software.

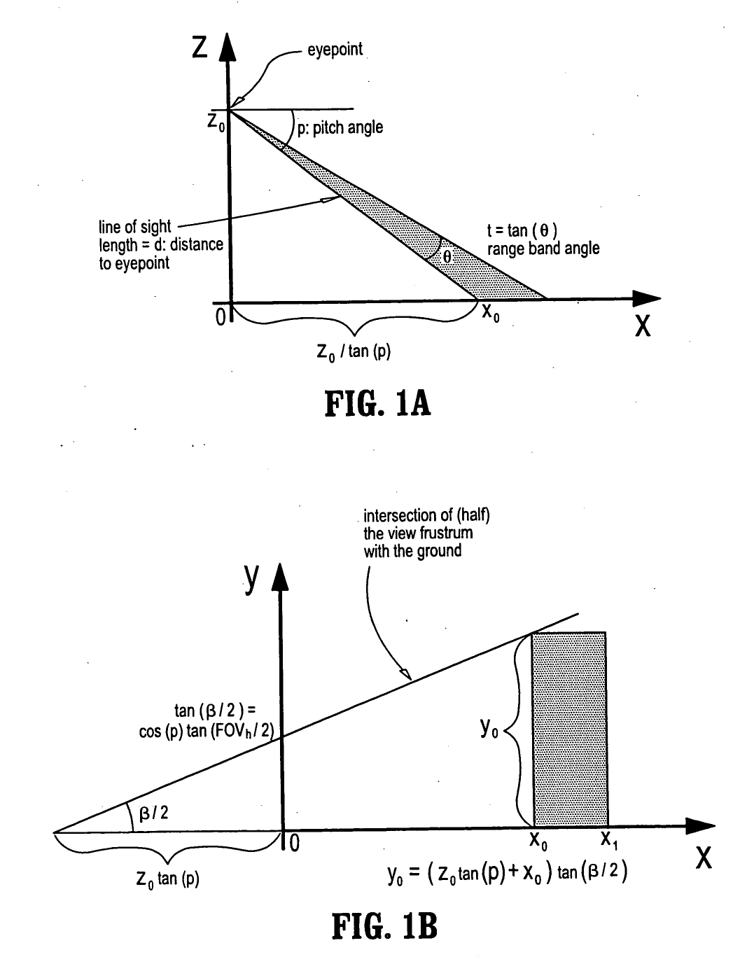

A system 110, in accordance with one embodiment shown in FIG. 1, includes user interface 111, feature analyzer 112 and display monitor 113. Feature analyzer 112 includes a scaling module 112a. User interface 111 and/or feature analyzer 112 may be a computer program stored on a computer readable medium and/or transmitted via a computer network or other transmission medium.

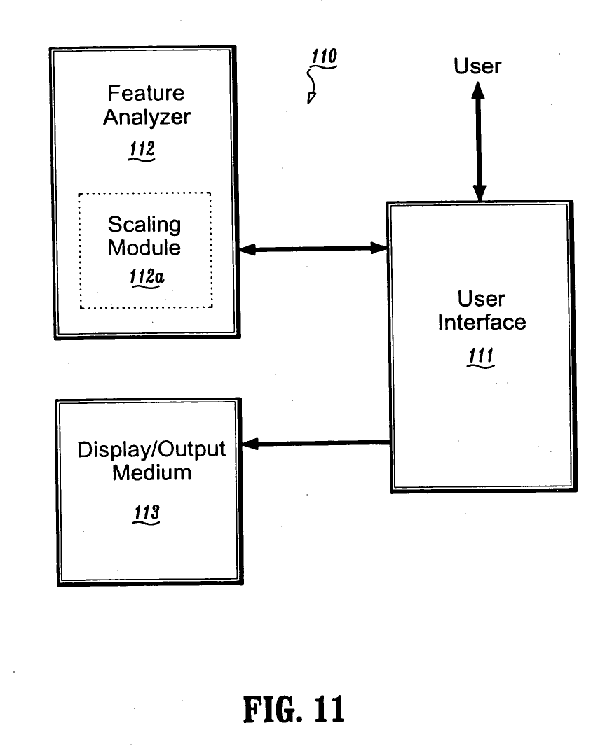

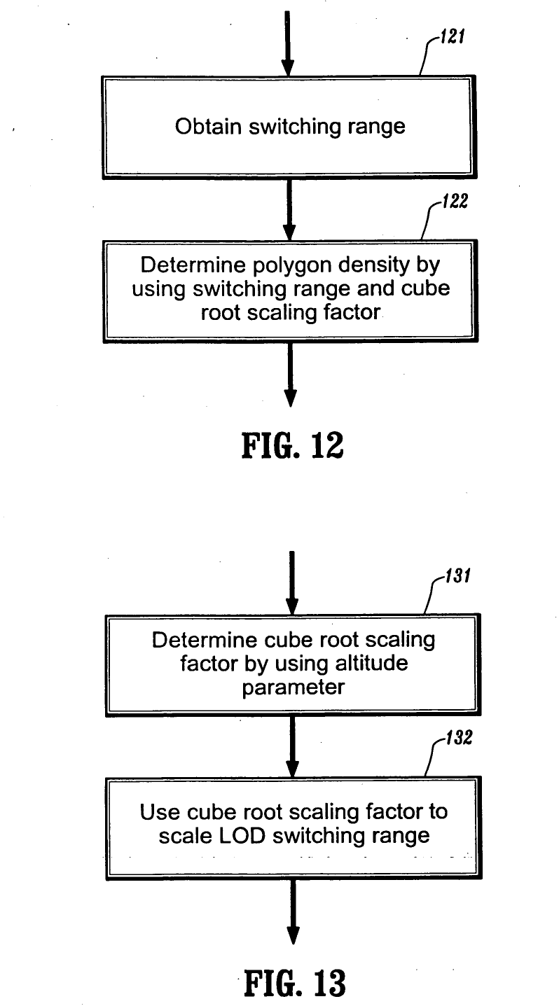

A method, according to one embodiment of the present application, for determining a spatial hierarchy for polygon data will be described with reference to FIGS. 11 and 12. A switching range is obtained through user interface 111 (step 121). A polygon density is determined by feature analyzer 112 using the switching range and a cube-root scaling factor (step 122).

A method, according to another embodiment of the present application, for determining a spatial hierarchy for polygon data will be described with reference to FIGS. 11 and 13. A cube-root scaling factor is determined by feature analyzer 112 based on an altitude parameter obtained through user interface 111 (step 131). Scaling module 112a of feature analyzer 112 uses the cube-root scaling factor to scale level-of-detail switching ranges for the spatial hierarchy (step 132).

A more detailed description of the system and methods for determining a spatial hierarchy for polygon data will now be provided.

Given a polygon budget, e.g., corresponding to the storage space in a database, an ideal polygon density on the ground (assumed to be flat) may be expressed as a function of an altitude of observation z, and the distance d to an eyepoint, as follows:

$$chaninfo * budget * ( z / {d}^{3} ) , where$$

$$chaninfo = \frac{1}{2 tan \frac{{FOV}_{h}}{2} ( tan {FOV}_{u} + tan {FOV}_{d} )}$$

FOVₕ denotes a horizontal field of view, FOVᵤ denotes an angle above the vertical line of sight, and FOV_{d} denotes an angle below the vertical line of sight.

For a given (design) altitude z₀, the equations above may be used to compute an (ideal) number of polygons that a polygon-tile may contain (depending upon the tile's switching range and extent).

When rendering at an altitude z significantly different from the design altitude z₀, the polygon budget may be violated, e.g., very few polygons at high altitudes, and too many at low altitudes. This can be prevented by scaling level-of-detail (LOD) switching ranges with cube-root scaling, (z/z₀)^{⅓}.

1 Analysis in the Continuum

1.1 Area on the Ground Corresponding to a Horizontal Screen Band

To compute the polygon density, referring to FIGS. 1A and 1B, a horizontal band of the computer screen (corresponding to an angle θ as seen from the eyepoint; t≈tan θ) is considered, and the corresponding area of the ground is determined as follows:

$$area ( {z}_{0} , d ) \approx 2 {y}_{0} ( {x}_{1} - {x}_{0} ) = 2 tan \frac{{FOV}_{h}}{2} \frac{{d}^{3}}{{z}_{0}} f ( p ) , \qquad ( 1 )$$

where FOVₕ denotes the horizontal field-of-view, p denotes the pitch angle zₒ the altitude of the eyepoint, and

$$f ( p ) = {sin}^{2} p ( \frac{1 + t tan p}{tan p - t} - \frac{1}{tan p} ) .$$

The intermediate results are as follows:

$$area = 2 {z}_{0}^{2} cos p tan \frac{{FOV}_{h}}{2} ( tan p + \frac{1}{tan p} ) ( \frac{1 + t tan p}{tan p - t} - \frac{1}{tan p} ) , \\ cos p ( tan p + \frac{1}{tan p} ) = sin p + \frac{{cos}^{2} p}{sin p} = \frac{1}{sin p} = \frac{{sin}^{2} p}{{sin}^{3} p} , where$$

$$sin p = \frac{{z}_{0}}{d} .$$

Equation (1) can be greatly simplified by choosing a very small θ, thus achieving t<<tanp, for all pitches (since the existence of a far clipping plane implies that p has a lower bound), such that the following is true:

$$f ( p ) = {sin}^{2} p \frac{t {tan}^{2} p + t}{( tan p - t ) tan p} ≃ t .$$

For computing a correct polygon density, when intersecting the horizontal field-of-view with the ground, the angle β is actually smaller than FOVₕ.

1.2 Polygon Density in the Continuum

To determine polygon density, a focal length is first determined from the vertical field-of-view parameters. As explained below, the number of vertical pixels that represent a given object is determined using the focal length.

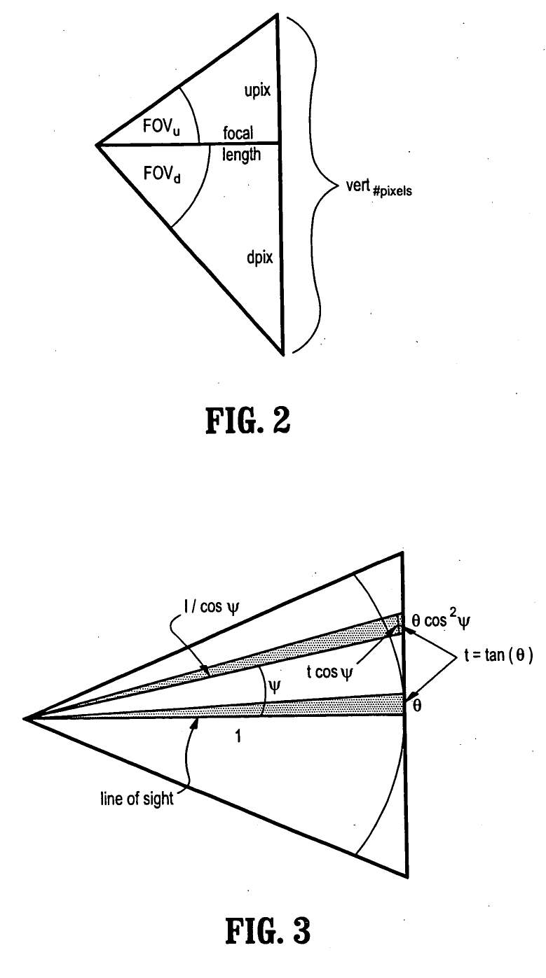

Referring to FIG. 2, the vertical field-of-view is, in general, non-symmetrical with an angle FOVᵤ above the vertical line-of-sight and angle FOV_{d} below the vertical line-of-sight. The following may be determined, with reference to FIG. 2:

$$vertical no . of pixels = upix + dpix , \\ focal length = upix / tan {FOV}_{u} = dpix / tan {FOV}_{d} , \\ focal length = \frac{vertical no . of pixels}{tan {FOV}_{u} + tan {FOV}_{d}} .$$

To infer density from Equation (1), the number of polygons n assigned to the horizontal screen band (angle θ) is divided with the area of Equation (1).

$$\frac{n}{budget} = t \frac{focal length}{vertical no . of pixels}$$

The following equation is obtained:

$$density ( z , d ) = \frac{n}{area ( z , d )} = chaninfo \cdot budget \cdot \frac{z}{{d}^{3}} . \qquad ( 2 )$$

1.3 Density Fall-Off and Correction

The density in the center of the screen (line of sight) typically is larger than at the periphery. An equal-screen-area vertical band corresponds to a smaller angle at the bottom and top edges of the screen. The overall fall-off for the up field-of-view is as follows, and a similar equation holds for the down field-of-view:

$$\frac{1}{{FOV}_{u}} {\int }_{0}^{{FOV}_{u}} {cos}^{2} ψ ⅆ ψ = \frac{1}{2} + \frac{sin 2 {FOV}_{u}}{4 {FOV}_{u}} \qquad ( 3 )$$

The total vertical density fall-off is an average of Equation (3) for the up and down fields of view, weighted by (tanFOVᵤ, tanFOV_{d}). With equal screen length increments (t), the angle corresponding with a screen band reduces with the angle from the center of the screen from θ down to θ cos²ψ, as shown in FIG. 3.

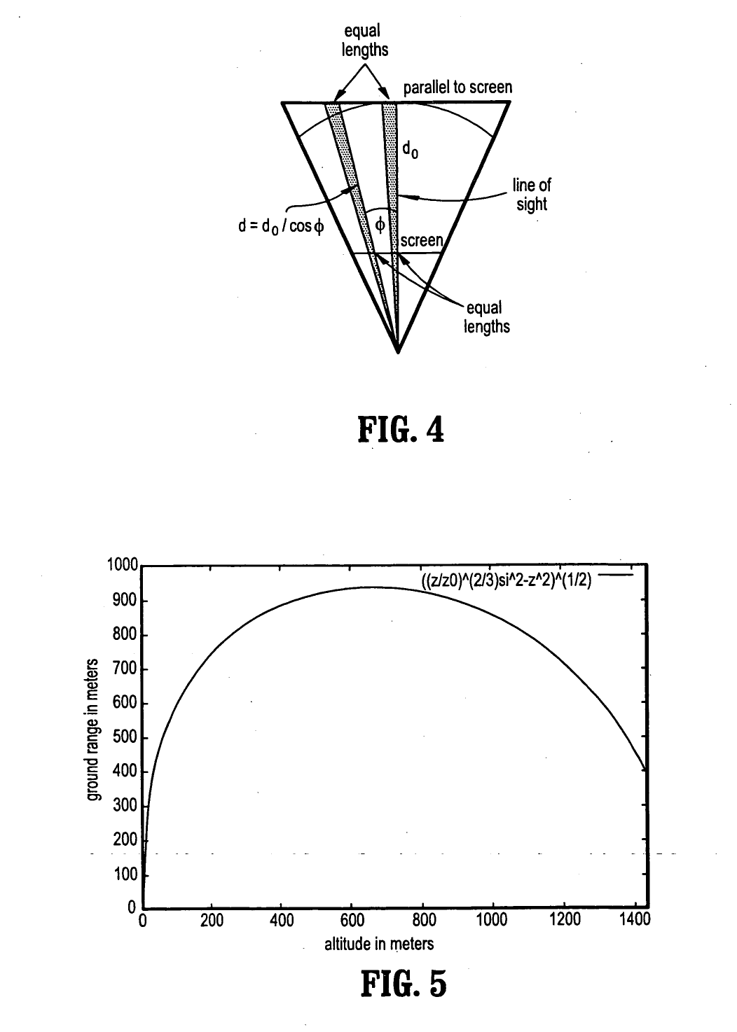

Referring now to FIG. 4, at the left and right edges of the screen, the distance to the objects projected on the screen is larger than at the center. The density is thus multiplied by cos³φ. The overall horizon fall-off (cos³φ) is as follows:

$$\frac{2}{{FOV}_{h}} {\int }_{0}^{\frac{{FOV}_{h}}{2}} {cos}^{3} φ ⅆ φ = \frac{sin ( 3 {FOV}_{h} / 2 ) + 9 sin ( {FOV}_{h} / 2 )}{6 {FOV}_{h}} \qquad ( 4 )$$

The polygon budget may be increased by dividing with the product of Equations (3) and (4). The maximum angle φ in Equation (4) is less than FOVₕ/2 for a deviation angle ψ from the vertical line of sight different from zero (the tangent of the maximum angle is multiplied by cosψ). Also, tiling artifacts may alleviate the horizontal fall-off. The density fall-off may be a beneficial phenomenon, assuming that the center of the screen deserves more detail.

2 Analysis for a Hierarchical Tiling System

2.1 Polygon-Density for a Tile

If (d₁, d₂) denotes the switching range of a tile, and z₀ the design altitude, a suitable density for the tile may be computed by averaging the overall polygon contribution of Equation (2) for the ground area covered between d₁ and d₂, as follows:

$$chaninfo \cdot budget \frac{{\int }_{{d}_{1}}^{{d}_{2}} \frac{{z}_{0}}{{r}^{3}} r ⅆ r}{{\int }_{{d}_{1}}^{{d}_{2}} r ⅆ r} = \frac{2 \cdot {z}_{0} \cdot chaninfo \cdot budget}{{d}_{1} {d}_{2} ( {d}_{1} + {d}_{2} )} , \\ \frac{\frac{1}{{d}_{1}} - \frac{1}{{d}_{2}}}{{d}_{2}^{2} - {d}_{1}^{2}} = \frac{1}{{d}_{1} {d}_{2} ( {d}_{1} + {d}_{2} )} . \qquad ( 5 )$$

Integrating over the ground range r is the same as integrating over the slant range (or distance) d, as shown by the following change of variables:

$$δ r = δ \sqrt{{d}^{2} - {z}^{2}} = \frac{d}{\sqrt{{d}^{2} - {z}^{2}}} δ d = \frac{d}{r} δ d , \\ r δ r = d δ d .$$

The polygon budget for the tile may be obtained by multiplying Equation (5) with the area of the tile.

Additive and substitutive tile hierarchies may be considered. In an additive tile hierarchy, the switch-out distance is zero for each tile. When children tiles switch in, they add to the polygon density. The parent is not switched out unless the distance to the tile center becomes larger than the switch-in distance for that tile.

In a substitutive hierarchy, when a tile switches out, the children tiles occupying the void left by the switched-out tile are forced to switch in, in substitution of the parent tile. It follows that only the switch-out information is used to determine visibility. The polygon density equation for a substitutive hierarchy is as follows:

$$\frac{2 \cdot {z}_{0} \cdot chaninfo \cdot budget}{{d}_{1} {d}_{2} ( {d}_{1} + {d}_{2} )} ,$$

where d₁ is the switch-out distance of the tile and d₂ is the “switch-in distance” (switch-out distance of the parent tile).

For an additive hierarchy, the same equation is used as a starting point, where d₂ denotes the tile switch-in distance and d₁ denotes the switch-in distance of the next smaller tile-set, and add to it the cumulative density of all larger tiles (because densities are being added).

2.2 Scaling the LOD Switching Ranges

To determine how the switching distances may be “transformed” to match the density curve for z₀ with the density curve for z, a constant density is imposed on Equation (2), and the cube-root scaling is derived directly as follows:

$$d = {d}_{0} \sqrt[3]{\frac{z}{{z}_{0}}} .$$

Equating the altitude with the switch-in distance sᵢ after it was scaled, the maximum altitude at which a given tile is visible is obtained as follows:

$$z = \sqrt[3]{\frac{z}{{z}_{0}}} {s}_{i} , \\ \begin{matrix}z = \sqrt{\frac{{s}_{i}^{3}}{{z}_{0}}} . & ( 6 )\end{matrix}$$

Using cube-root scaling at altitudes significantly smaller than the smaller tile's switch-in radius may not be suitable under some circumstances. For example, cube-root scaling matches ideal density curves, and thus assumes that smaller tiles with yet higher densities are indefinitely available.

Also, once the altitude is smaller than some fraction of the smallest switch-in radius, all ground ranges increases only minimally when altitude decreases. The polygon counts thus stay approximately constant without scaling. For example, the second observation, the ground range r of the smallest tile may be plotted as a function of altitude as shown in FIG. 5, assuming scaling is turned on, using the following:

$${r}^{2} = {( \frac{z}{{z}_{0}} )}^{\frac{2}{3}} {s}_{i}^{2} - {z}^{2} ,$$

where sᵢ is the static (before scaling) switch-in radius of that tile. The altitude corresponding to the largest range, which is obtained by solving for the altitude that sets the derivative of r² to zero, is as follows:

$$\sqrt{\frac{{s}_{i}^{3}}{\sqrt{27} {z}_{0}}} .$$

This altitude corresponds to a good clamping altitude for scaling. Below that altitude, scaling reduces polygon counts for all levels simultaneously, with no additional level to fill the gap.
2.3 Recommending Sizes for Objects Populating Each Set of Tiles

The user defines a MINPIX value, as well as a MAXPIX value, e.g., [1 pixel, 4 pixels]. MINPIX is the smallest size in (vertical) pixels (the channel does not necessarily use square pixels) that an object may be. MAPIX is the largest size in (vertical) pixels an object can be when it switches (or “pops”) in and out of the scene.

Consider the following:

$$size [ meters ] = d \cdot \frac{size [ pixels ]}{focal length} . \qquad ( 7 )$$

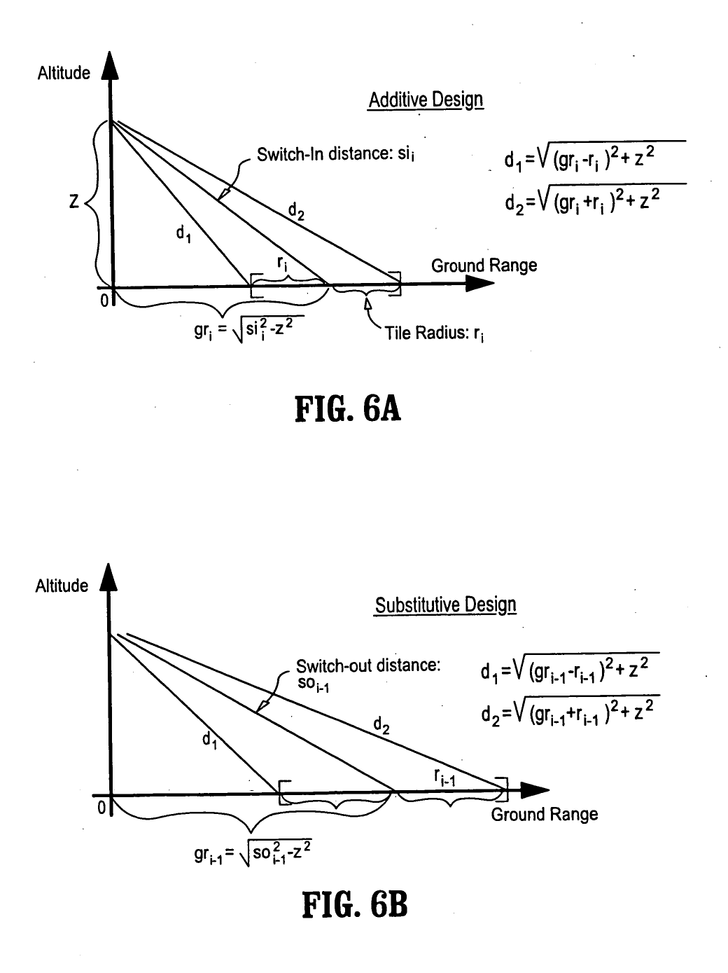

FIGS. 6A and 6B show in respective additive and substitutive schemes the distances for determining suitable object sizes using Equation (7), using MINPIX for d₂ and MAXPIX for d₁. Thus, a minimum and a maximum object size may be determined for all altitudes at which a tile is visible [see Equation (6)].

The user may specify the ground range of the smallest tile, e.g., expressed in a factor of the tile's diameter. A number in the vicinity of three is a reasonable choice, which specifies that ten to twenty or so such tiles are visible. The design altitude z₀ may be set to within this ground range, as described above. Scaling works better up than down (limitation of the smallest tile). However, the design altitude cannot be much smaller than this first ground range (providing some up-and-down scaling leverage before having to clamp scaling).

With z₀ determined as described, the first switch-in distance can be determined. Subsequent switch-in distances can be set so as to have approximately the same polygon count in each tile (with potentially some tuning). For example, if the tiles double in size (as in a quad-tree), the density is divided by four, which occurs when multiplying the switch-in distance by (4)^{⅓}≈1.6 [see Equation (2)].

Cube-root scaling matches exactly the (ideal) density curves at varying altitudes. In order to use a single scale for the entire polygonal database, the polygon-tiles may be designed at the same altitude and Equation (5) used, even if not all tiles are visible, to prescribe a density.

An exemplary embodiment is described below. The embodiment uses a spreadsheet to provide a user interface. It should be understood, however, that other types of user interface may be used also or alternatively. For example, the user interface may be one or a combination of standard, conventional or application specific graphical user interfaces. The user interface may also include voice interface features, which are also conventionally known and therefore not discussed in detail here.

3 Point Feature Density Analysis Tool

The Point Feature Density Analysis Tool (PFDA) may be provided for specifiing a tile-based spatial hierarchy for polygon data representing, e.g., cultural features. The information that may be specified includes the type of hierarchy (additive or substitutive), a number of levels in the hierarchy, an extent of tiles for each level of the hierarchy, and switching distances for tiles of each level. The specified information also may include polygon densities to be applied to each level, a LOD scaling function (which is a function of altitude), and a critical size (described below) of the polygonal elements to be inserted in each level. The PFDA provides a user interface and a feature analyzer. A Point Feature Selection and Allocation Tool (not discussed herein) optionally may be provided for assigning actual features to tiles of a culture hierarchy.

Critical size is the size of a feature as perceived on the display, or difference in sizes between two representations of the same feature. In general, this is the largest dimension of the feature, but other cases may apply depending upon the type of feature. Examples of some special cases include airports, radio towers and other “wireframe” features, and features that are particularly elongated. When substituting models, a measure of the difference between the two models is used.

Critical size is used to determine the range at which a model is appropriate in the scene. An extreme example is a model of a house with a textured picture of a door at a low LOD and a polygonal doorframe at a high LOD. The critical size of the high LOD is only ½ inch! Although the door is 7×3 feet, the frame of the door is only relevant when the observer is close enough to discriminate the ½ inch thickness of the door. Critical size is a modeling consideration, and can only be grossly approximated by algorithmic inspection of the model's geometry.

The PFDA may be implemented, according to one embodiment, as an Excel spreadsheet for analyzing point features (buildings, bridges, trees, etc.), but also may provide means for analyzing other visual elements. The PFDA may have a built-in validation step, by which visible tiles are interactively computed for a wide range of altitudes and lines of sight, to simulate how the polygon budget is utilized under various settings, assuming that recommendations for polygon counts per tile are followed.

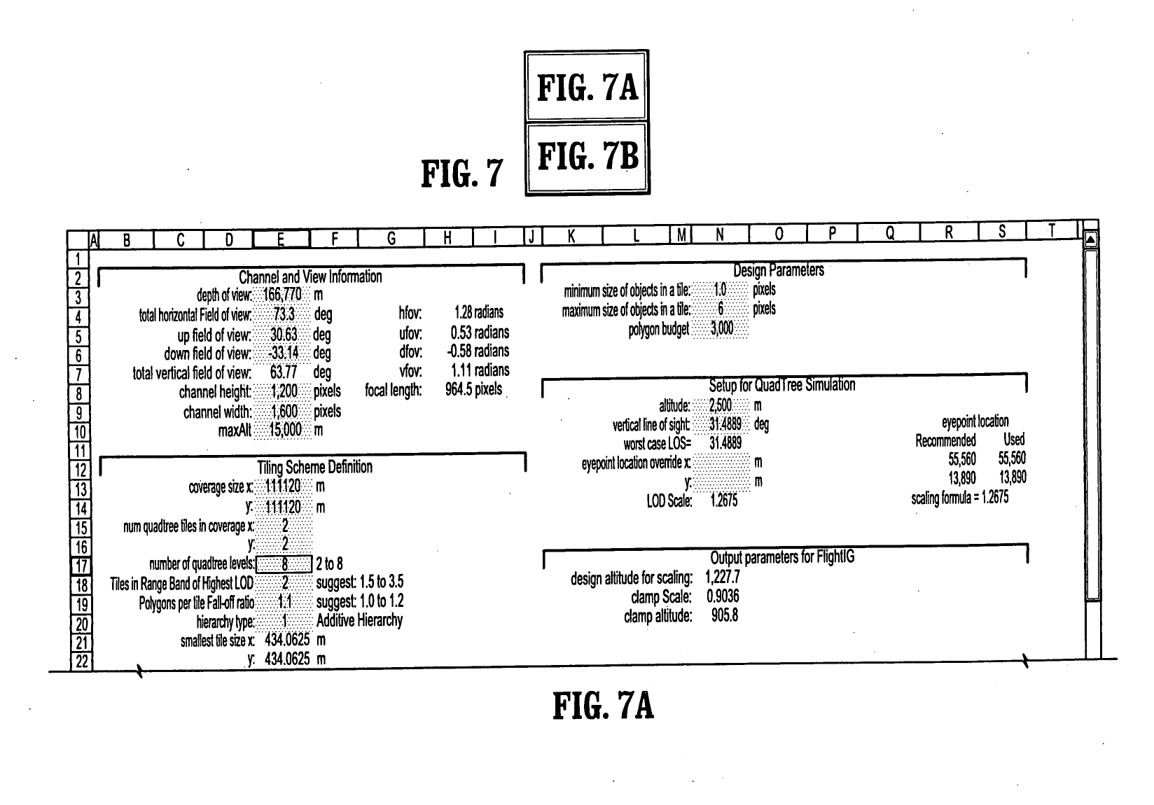

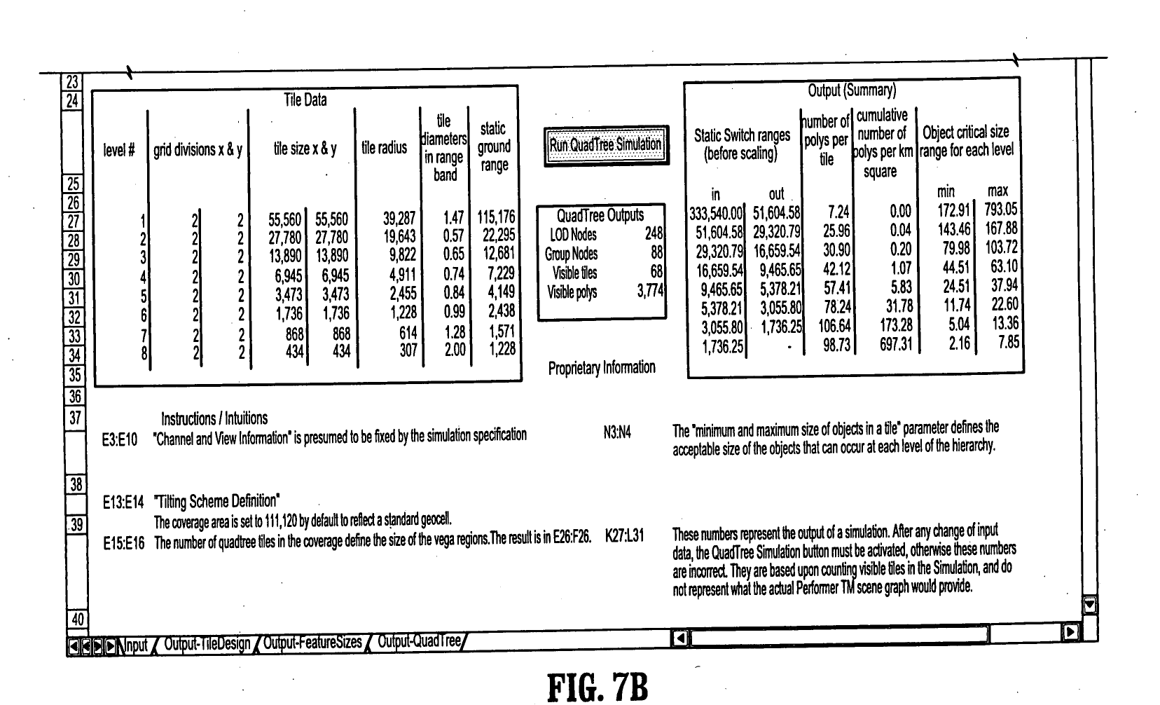

FIG. 7 shows an exemplary Input sheet. The following inputs provided by the PFDA may be modified by the user: (a) channel and view information, including horizontal and vertical fields of view, numbers of pixels, depth of view (distance to far clipping plane); (b) tiling scheme definition, including coverage of a geo-cell in meters, number of quad-tree levels, and number of quad-trees in a geo-cell; (c) design parameters, including polygon budget, minimum size of an object on the screen in pixels (minpix) and maximum size (maxpix) when the corresponding tile switches in or out, and maximum altitude maxAlt to which minpix and maxpix are relevant; and (d) setup for quad-tree display (design validation), including vertical line of sight, elevation, and x,y coordinates of the eyepoint. Once the channel and view information, as well as design parameters, are entered, the bulk of the design work consists of completing the tiling scheme definition.

Design definitions may be entered in cells N3-6. The user specifies the “minimum and maximum size of objects in a tile” (minpix and maxpix) parameters in cells N3-4. Minpix refers to how small any object can be at any time on the screen (generally, one pixel is a reasonable choice). Maxpix refers to how large an object can be when it “pops” in and out as its tile switches in or out. If an object is substituted with a different LOD of that object, then the visual difference between the two is what is measured. The polygon budget may be entered in cell N5. The maximum altitude for which minpix and maxpix are relevant may be entered in cell N6.

Tiling scheme definition may be entered via cells E13-20. The overall coverage size is specified in cells E13-14. The user may choose to divide it in any (integer) number of quad-trees in the x and y directions E15-16.

The number of quad-tree levels may be entered in cell E17, and typically is between 2 and 8. The number of valid levels also may be reflected in output sheets. More levels in the quad-tree yield smaller tiles at the highest LOD and thus also the opportunity for smaller features. This comes at the expense of increased cull depth and larger memory footprint for region files.

The number of tiles in the first range band (highest LOD) may be entered in cell E18, and is a parameter of particular interest. When increasing this number, all the range bands increase in size, following the first band. A finer granularity of the quad-tree is thus obtained, often corresponding to a more graceful matching of the polygon budget. This is obtained at the expense of lower polygon counts per tile, and a larger cull and switching load. Lowering this number causes tile switching to be more aggressive, and therefore increases the likelihood that levels of the hierarchy are skipped in substitutive designs. Quad-Tree simulation provides a visualization of this effect.

The “polygons per tile fall-off ratio” may be entered in cell E19, and used to control the number of polygons per tile for subsequent Quad-Tree LODs. When set to 1, it is approximately constant. When increased, the number of polygons per tile decreases and the sizes of the range bands decreases.

The type of hierarchy (additive=1, substitutive=0) is specified in cell E20. An additive hierarchy causes features to switch in and stay in as the observer approaches. In substitutive hierarchies, features are replaced with higher polygon count versions as the observer approaches. This selection has a major impact on the way density is distributed throughout the scene and the type of models that are used. Quad-Tree simulation provides a visualization of this effect.

A summary of outputs (rows 24 through 35) may be provided on the Input sheet (see FIG. 7). Switch range (slant range) for each tile is shown in cells N27-O34. The switching ranges are subjected to altitude-based scaling performed by the scaling module. The output parameters for scaling in the scaling module are provided in cells N18-19 of the Input sheet. The scaling module scales these values depending upon altitude using the information in N18:20.

Cells P27-Q34 show actual polygon budget for each tile and actual density in number of polygons per 1 km square. Using the inputs the user may determine what cumulative density is reasonable. Decreasing the number of Quad-Tree levels (E17), decreases significantly the density of the highest level. Increasing the number of quad-trees in the coverage (E15:16) increases this density. Increasing the number of tiles in the range band of the highest level (E18) decreases the density and the polygons per tile. Increasing polygons per tile fall-off ratio (E19) only affects the polygons per tile of the subsequent levels (lower than highest level), but not the polygon count and density of the highest level.

Cells R27-T34 show recommended minimum and maximum object sizes for each tile, based upon the information input in cells N3:N4. If the minimum size exceeds the maximum size, Min>Max appears in the T column. The size distribution is satisfactory if “Min>Max” does not occur, if the range of sizes match the user's data, and if the gaps are not too wide between tiles. Increasing the number of Quad-Tree levels provides a larger distribution and smaller sizes. Increasing the number of Quad-Trees per coverage decreases the sizes globally. Increasing the polygons/tile fall-off ratio may eliminate Min>Max problems, at the expense of fewer polygons in the larger tiles. The same applies to increasing the number of tiles in the range band of the highest level. Again, after changing any of these, the user may press the Quad-Tree Simulation button to validate the new culling load and number of visible tiles.

To validate the number of visible tiles of each type and the number of visible polygons for a given altitude, the Quad-Tree macro may be activated by pressing the “Run QuadTree Simulation” button in cells K25-L25. A graphical display of the visible tiles for the chosen altitude (N9) and line of sight (N10) is then produced in the Output-QuadTree sheet (FIG. 10).

Cells K27-L31 show a summary of the validation/simulation, including a measure of the LOD culling (L28) and frustrum culling (L29) load. The number of visible tiles (L30) and polygons (L31) also may be provided. The number of polygons indicated in cell L31 correspond approximately to the budget, depending upon the altitude (N9), vertical line of sight (N10) and eyepoint location (N12-13). After any change of input data, the “Run QuadTree Simulation” button is activated, so that these numbers may be updated. They are based upon counting visible tiles in the simulation, and do not represent what an actual scene graph may provide.

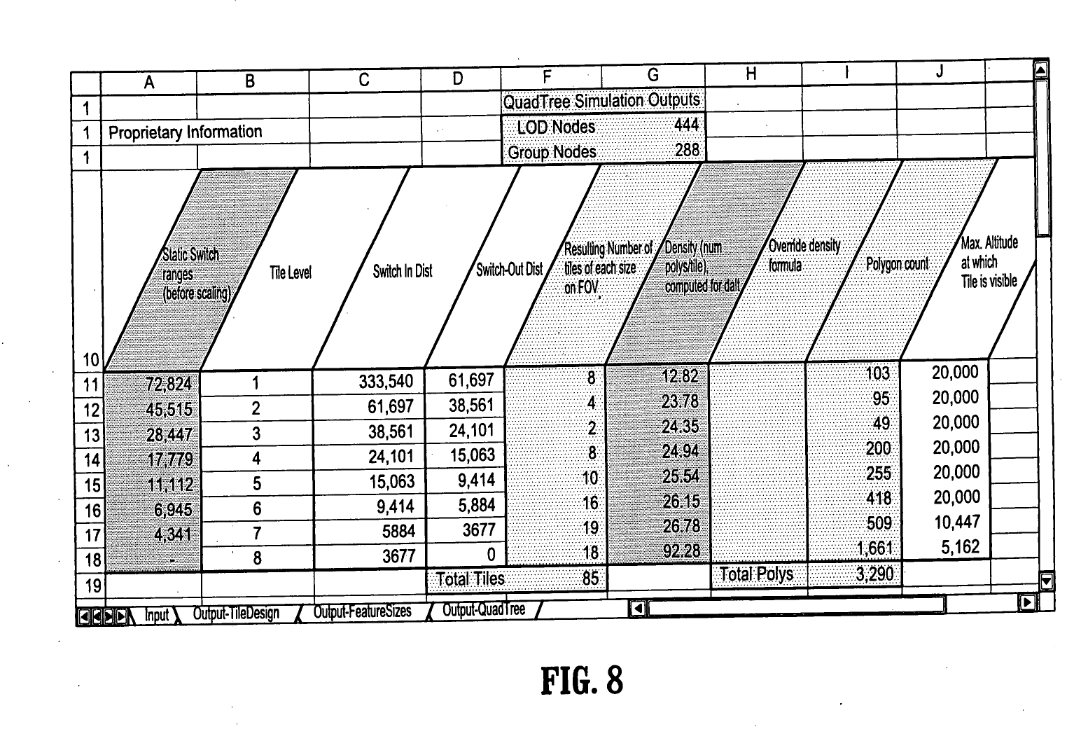

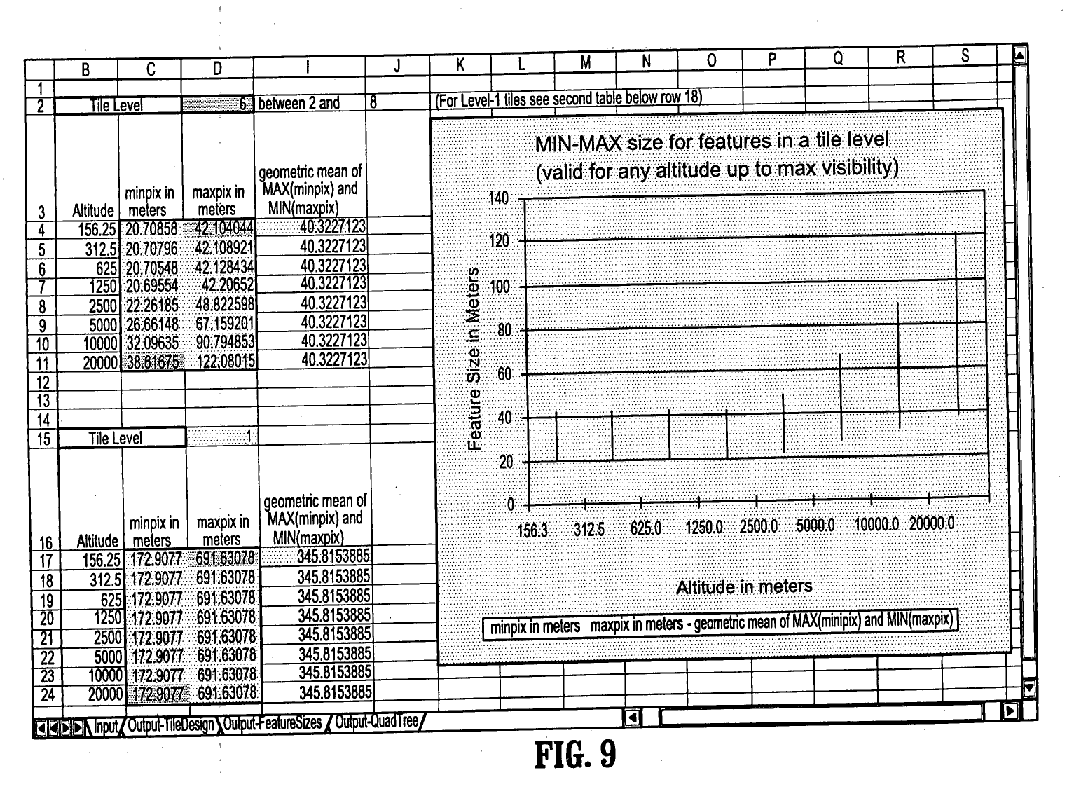

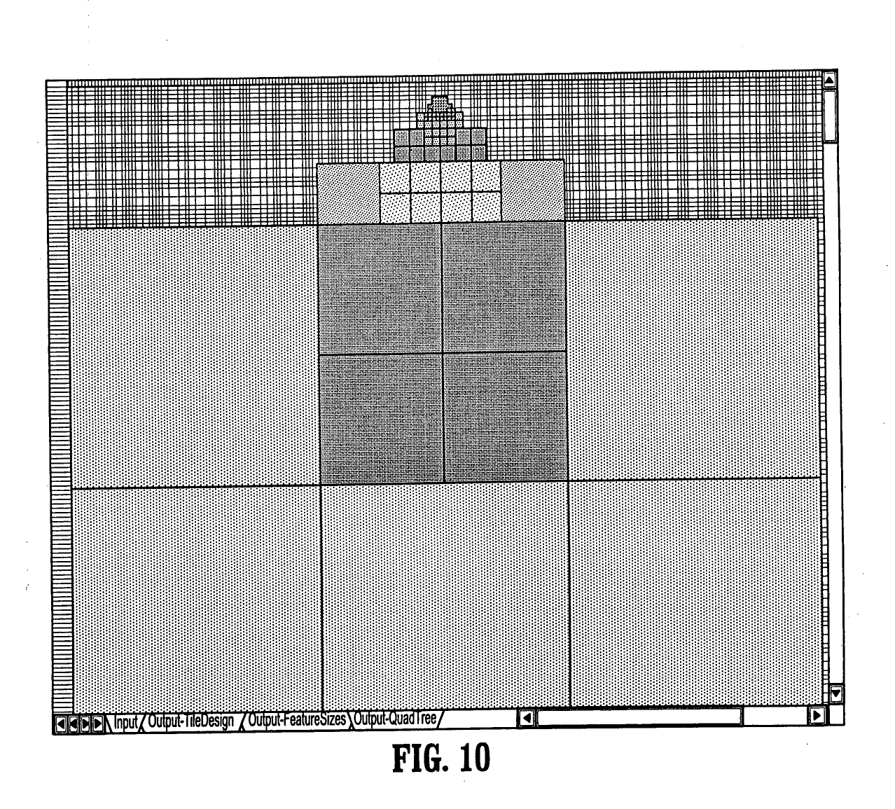

More detailed output information may be supplied on other sheets, as shown for example in FIGS. 8-10, including the following: (1) polygon counts per tile and tile static switching ranges (Output-TileDesign sheet: FIG. 8); (2) recommended minimum and maximum feature critical sizes for a range of altitudes (Output-FeatureSizes sheet: FIG. 9) that shows the tiles selected given the input conditions; and (3) graphical validation of the selected design (Output-QuadTree sheet: FIG. 10).

Outputs in the Output-TileDesign Sheet (FIG. 8) will now be described. The static switch ranges (cells A11-18) and polygon counts per tile (G11-18) computed in this worksheet are copied in the Input sheet. The user may override the polygon density equation by typing a number of his/her choice in cells H11-18.

When Quad-Tree validation is performed (triggered by depressing the “Run QuadTree” button in the Input Sheet), validation output is provided, including culling and LOD switching loads (G2,G3), visible tiles (F11-19) and visible polygon counts (I11-19). These visible tiles and polygons are computed using the simulation, but are NOT used for density computations (a general equation is used instead). They depend upon the viewing parameters (altitude, pitch angle, eyepoint x and y locations). The simulation performs tile culling only, as opposed to precise view-frustrum culling. Also, the viewing frustrum may be larger than the working space of the simulation. Therefore, the input polygon budget is not exactly matched in cell 119. Further, the simulation assumes that exact polygon counts (G11-18, or H11-18 when the user decides to override) are applied to each tile, as shown by an artifact of aggregating features into geographic tiles. Varying the simulation's eyepoint location result in aliasing effects in the tile culling process. “Dynamic culture scaling” is enabled within the scaling module.

Outputs in the Output-FeatureSizes Sheet (FIG. 9) will now be described. The lower table (B17-124) specifies the range of feature critical sizes for the largest LOD-tile level (LOD 1). The minpix and maxpix input values are transformed into feature critical sizes in meters for a spectrum of altitudes, starting with maxAlt as specified in the Input sheet, and decreasing in exponential steps. A size less than cell B24 and larger than cell C17 does not violate a constraint, at all altitudes. The value in cell I17, repeated in cells I18-24, is the geometric mean of cells B24 and C17.

The upper table (B4-I11) applies to other LODs. The user specifies the appropriate LOD number in cell D2. The chart to the right illustrates the minimum and maximum feature critical sizes corresponding to the upper table.

The Output-QuadTree sheet (FIG. 10) provides a graphical layout of visible tiles following level-of-detail and view-frustrum culling, after the “Run QuadTree Simulation” button in the Input sheet is pressed.

The above specific embodiments are illustrative, and many variations can be introduced on these embodiments without departing from the spirit of the disclosure or from the scope of the appended claims. Elements and/or features of different illustrative embodiments may be combined with each other and/or substituted for each other within the scope of this disclosure and appended claims.

For example, additional variations may be apparent to one of ordinary skill in the art from reading U.S. provisional application Ser. No. 60/279,181, filed Mar. 27, 2001, which is incorporated herein by reference.

1. A method of determining a spatial hierarchy for polygon data, comprising:
obtaining a switching range; and
determining a polygon density for the spatial hierarchy, by using the switching range and a cube-root scaling factor.

2. The method of claim 1, wherein the cube-root scaling factor is determined based on an altitude parameter.

3. The method of claim 1, wherein the spatial hierarchy is tile-based.

4. The method of claim 1, wherein the polygon data corresponds to cultural features.

5. The method of claim 1 further comprising providing a user interface, wherein design parameters of the spatial hierarchy are obtained and/or modified through the user interface.

6. The method of claim 5, wherein a number of levels in the spatial hierarchy is obtained and/or modified through the user interface.

7. The method of claim 5, wherein an extent of tiles for each level of the spatial hierarchy is obtained and/or modified through the user interface.

8. The method of claim 5, wherein a critical size of polygonal elements to be inserted in each level of the spatial hierarchy is obtained and/or modified through the user interface.

9. The method of claim 5, wherein a switching distance for tiles of each level of the spatial hierarchy is obtained and/or modified through the user interface.

10. A system for determining a spatial hierarchy for polygon data, comprising:
a user interface; and
a feature analyzer for determining a polygon density for the spatial hierarchy, by using (i) a switching range obtained through the user interface and (ii) a cube-root scaling factor.

11. The system of claim 10, wherein the cube-root scaling factor is determined based on an altitude parameter.

12. The system of claim 10, wherein the spatial hierarchy is tile-based.

13. The system of claim 10, wherein the polygon data corresponds to cultural features.

14. The system of claim 10, wherein design parameters of the spatial hierarchy are obtained and/or modified through the user interface.

15. The system of claim 14, wherein a number of levels in the spatial hierarchy is obtained and/or modified through the user interface.

16. The system of claim 14, an extent of tiles for each level of the spatial hierarchy is obtained and/or modified through the user interface.

17. The system of claim 14, wherein a critical size of polygonal elements to be inserted in each level of the spatial hierarchy is obtained and/or modified through the user interface.

18. The system of claim 14, wherein a switching distance for tiles of each level of the spatial hierarchy is obtained and/or modified through the user interface.

19. A program storage device readable by a machine, tangibly embodying a program of instructions executable by the machine to perform method steps for determining a spatial hierarchy for polygon data, the method steps comprising:
obtaining a switching range; and
determining a polygon density for the spatial hierarchy, by using the switching range and a cube-root scaling factor.

20. A computer data signal embodied in a transmission medium which embodies instructions executable by a computer for determining a spatial hierarchy for polygon data, comprising:
a first segment including user interface code; and
a second segment including feature analysis code to determine a polygon density for the spatial hierarchy, by using (i) a switching range obtained through the user interface code and (ii) a cube-root scaling factor.

21. A method of determining a spatial hierarchy for polygon data, comprising:
determining a cube-root scaling factor based on an altitude parameter; and
using the cube-root scaling factor to scale level-of-detail switching ranges for the spatial hierarchy.
